(19) United States
(12) Patent Application Publication
(10) Pub. No.: US 2025/0324029 A1
(43) Pub. Date: Oct. 16, 2025

(54) INTRA PREDICTOR AND INTRA MODE CODING

(71) Applicant: Tencent America LLC, Palo Alto, CA (US)

(72) Inventors: Biao WANG, San Jose, CA (US); Roman CHERNYAK, Santa Clara, CA (US); Lien-Fei CHEN, Palo Alto, CA (US); Yonguk YOON, Palo Alto, CA (US); Motong XU, Palo Alto, CA (US); Ziyue XIANG, Palo Alto, CA (US); Yifan WANG, Palo Alto, CA (US); Shan LIU, San Jose, CA (US); Tianqi LIU, Palo Alto, CA (US)

(73) Assignee: Tencent America LLC, Palo Alto, CA (US)

(21) Appl. No.: 19/177,348

(22) Filed: Apr. 11, 2025

Related U.S. Application Data
(60) Provisional application No. 63/633,840, filed on Apr. 14, 2024.
(60) Provisional application No. 63/635,618, filed on Apr. 17, 2024.
(60) Provisional application No. 63/637,332, filed on Apr. 22, 2024.

(51) Int. Cl. H04N 19/105; H04N 19/11; H04N 19/132; H04N 19/159; H04N 19/172; H04N 19/176; H04N 19/18; H04N 19/189; H04N 19/61

(52) U.S. Cl. CPC H04N 19/105; H04N 19/11; H04N 19/132; H04N 19/159; H04N 19/172; H04N 19/176; H04N 19/18; H04N 19/189; H04N 19/61

(57) ABSTRACT

A video bitstream including coded information of a current block in a current picture is received. The coded information indicates a plurality of candidate intra prediction modes for the current block. Two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The current block is reconstructed based on a weighted combination of the two or more predictors.

### INCORPORATION BY REFERENCE

The present application claims the benefit of priority to U.S. Provisional Application No. 63/633,840, “FUSED INTRA PREDICTION MODE INCLUDING TRAINING-BASED INTRA PREDICTOR” filed on Apr. 14, 2024, U.S. Provisional Application No. 63/635,618, “INTRA MERGE CANDIDATE DERIVATION BY USING INTRA TEMPLATE-MATCHING” filed on Apr. 18, 2024, and U.S. Provisional Application No. 63/637,332, “INTRA PREDICTION IN SPECTRUM DOMAIN FOR VIDEO CODING” filed on Apr. 22, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of video decoding is provided. In the method, a video bitstream including coded information of a current block in a current picture is received. The coded information indicates a plurality of candidate intra prediction modes for the current block. Two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The current block is reconstructed based on a weighted combination of the two or more predictors.

According to an aspect of the disclosure, a method of video decoding is provided. In the method, a video bitstream including coded information of a current block in a current picture is received. The coded information indicates a plurality of pre-defined merge candidates for the current block. The plurality of pre-defined merge candidates is refined to generate a plurality of refined merge candidates based on intra template matching between a template of the current block and one or more candidate templates associated with each of the plurality of pre-defined merge candidates. The current block is reconstructed based on the plurality of refined merge candidates.

According to an aspect of the disclosure, a method of video decoding is provided. In the method, a video bitstream including coded information of a current block in a current picture is received. A spatial to spectrum transform is performed on a reference region of the current block to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block. A plurality of transform coefficients corresponding to samples of the current block is determined based on the first row of transform coefficients and the first column of transform coefficients. The samples of the current block are reconstructed by performing an inverse transform on the plurality of transform coefficients.

According to another aspect of the disclosure, a method of video encoding is provided. In the method, a plurality of candidate intra prediction modes is determined for a current block in a current picture. Two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The current block is encoded into a bitstream based on a weighted combination of the two or more predictors.

According to another aspect of the disclosure, a method of video encoding is provided. In the method, a plurality of pre-defined merge candidates is determined for a current block in a current picture. The plurality of pre-defined merge candidates is refined to generate a plurality of refined merge candidates based on intra template matching between a template of the current block and one or more candidate templates associated with each of the plurality of pre-defined merge candidates. The current block is encoded into a bitstream based on the plurality of refined merge candidates.

According to another aspect of the disclosure, a method of video encoding is provided. In the method, a spatial to spectrum transform is performed on a reference region of a current block in a current picture to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block. A plurality of transform coefficients corresponding to samples of the current block is determined based on the first row of transform coefficients and the first column of transform coefficients. The samples of the current block are encoded by performing an inverse transform on the plurality of transform coefficients.

According to yet another aspect of the disclosure, a method of processing visual media data is provided. In the method, a bitstream of the visual media data is processed according to a format rule. The bitstream includes coded information of a current block in a current picture. The coded information indicates a plurality of candidate intra prediction modes for the current block. The format rule specifies that two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The format rule specifies that the current block is processed based on a weighted combination of the two or more predictors.

According to yet another aspect of the disclosure, a method of processing visual media data is provided. In the method, a bitstream of the visual media data is processed according to a format rule. The bitstream includes coded information of a current block in a current picture. The coded information indicates a plurality of pre-defined merge candidates for the current block. The format rule specifies that the plurality of pre-defined merge candidates is refined to generate a plurality of refined merge candidates based on intra template matching between a template of the current block and one or more candidate templates associated with each of the plurality of pre-defined merge candidates. The format rule specifies that the current block is processed based on the plurality of refined merge candidates.

According to yet another aspect of the disclosure, a method of processing visual media data is provided. In the method, a bitstream of the visual media data is processed according to a format rule. The bitstream includes coded information of a current block in a current picture. The format rule specifies that a spatial to spectrum transform is performed on a reference region of the current block to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block. The format rule specifies that a plurality of transform coefficients corresponding to samples of the current block is determined based on the first row of transform coefficients and the first column of transform coefficients. The format rule specifies that the samples of the current block are processed by performing an inverse transform on the plurality of transform coefficients.

Aspects of the disclosure also provide an apparatus for video decoding. The apparatus for video decoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods.

Technical solutions of the disclosure include methods and apparatuses to improve accuracy and efficiency of intra prediction in video coding based on (i) a fusion of at least two predictors, (ii) TM to improve merge candidate positions, and (iii) a spectrum domain-based intra prediction mode.

In an example, a video bitstream including coded information of a current block in a current picture is received. The coded information indicates a plurality of candidate intra prediction modes for the current block. Two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The current block is reconstructed based on a weighted combination of the two or more predictors.

In an example, a video bitstream including coded information of a current block in a current picture is received. The coded information indicates a plurality of pre-defined merge candidates for the current block. The plurality of pre-defined merge candidates is refined to generate a plurality of refined merge candidates based on intra template matching between a template of the current block and one or more candidate templates associated with each of the plurality of pre-defined merge candidates. The current block is reconstructed based on the plurality of refined merge candidates.

In an example, a video bitstream including coded information of a current block in a current picture is received. A spatial to spectrum transform is performed on a reference region of the current block to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block. A plurality of transform coefficients corresponding to samples of the current block is determined based on the first row of transform coefficients and the first column of transform coefficients. The samples of the current block are reconstructed by performing an inverse transform on the plurality of transform coefficients.

By employing (i) the fusion of at least two predictors, (2) TM to improve merge candidate positions, and/or (3) a spectrum domain-based intra prediction mode, the accuracy and efficiency of intra prediction in video coding are improved.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of an example of intra prediction from a matrix multiplication with reference samples.

FIG. 5 is a schematic illustration of an example of derivation of an intra prediction mode using a template.

FIG. 6 is a schematic illustration of an example of intra template-matching.

FIG. 7 is a schematic illustration of an example of neighboring blocks for intra prediction mode inheritance.

FIG. 8 is a schematic illustration of an example of refinement of a pre-defined merge candidate position.

FIG. 9 is a schematic illustration of an example of clustering of pre-defined merge candidates.

FIG. 10 is a schematic illustration of an example of intra prediction mode derivation within a reference block.

FIG. 11 is a schematic illustration of an example of an occurrence-based intra mode derivation using template-matching.

FIG. 12 is a schematic illustration of an example of a template of a block.

FIG. 13 is a schematic illustration of an example of a spectrum domain-based intra prediction mode.

FIG. 14 is a schematic illustration of an example of a spectrum domain-based intra prediction mode using multiple reference lines.

FIG. 15 shows a flow chart outlining a decoding process according to some aspects of the disclosure.

FIG. 16 shows a flow chart outlining a decoding process according to some aspects of the disclosure.

FIG. 17 shows a flow chart outlining a decoding process according to some aspects of the disclosure.

FIG. 18 is a schematic illustration of a computer system in accordance with an aspect.

### DETAILED DESCRIPTION

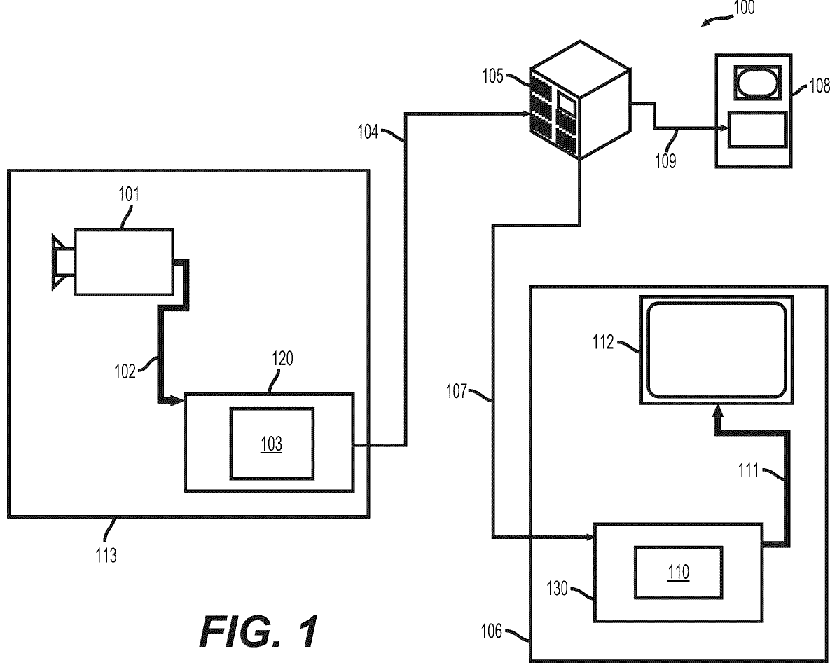

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

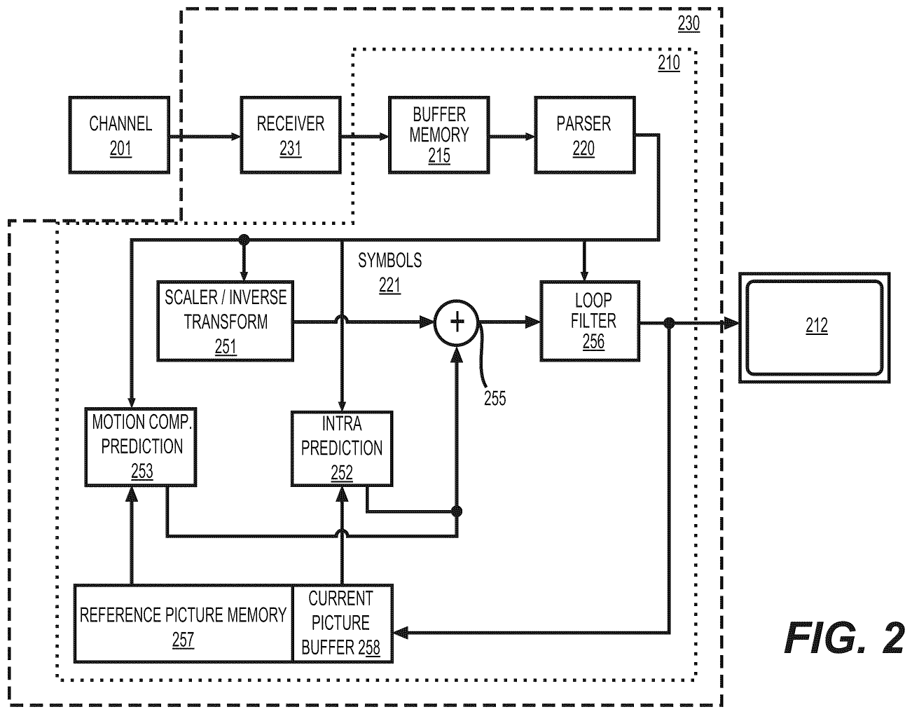

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

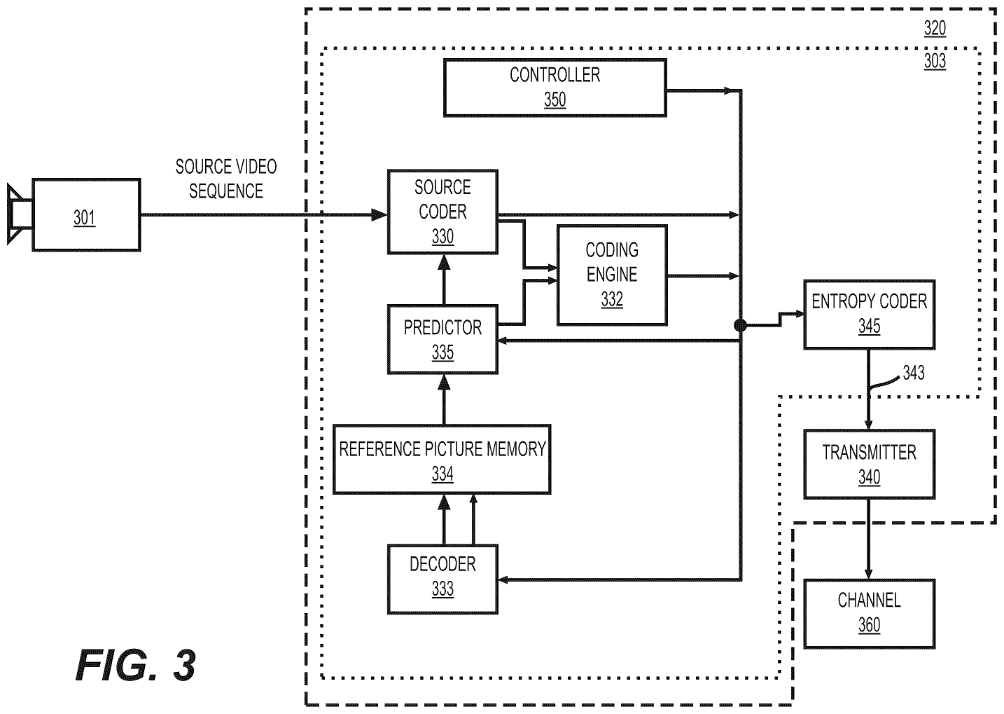

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure includes techniques for fused intra prediction mode based on a training-based intra predictor, and/or intra merge candidate derivation based on template-matching in an intra reconstructed picture, and intra prediction in a spectrum domain for video coding.

Video coding has been widely used in many applications. Various video coding standards, such as H264, H265, H266 (VVC), AV1, and AVS, have been widely adopted. A video codec may include a plurality of modules, such as an intra/inter prediction, a transform coding, a quantization, an entropy coding, an in-loop filtering, etc. Aspects of the disclosure include methods related to video compression, such as related to template matching prediction.

Intra prediction explores spatial redundancy between a current block and neighboring samples of the current block. Intra prediction modes may be classified as directional and non-directional modes, indicating directional or non-directional correlations between neighboring reference blocks and the current block. Examples of a non-directional intra prediction mode include a planar mode and a DC mode.

In a first method, an intra prediction mode may be explicitly signaled and a corresponding prediction signal may be generated using an interpolation filter applied on reference samples.

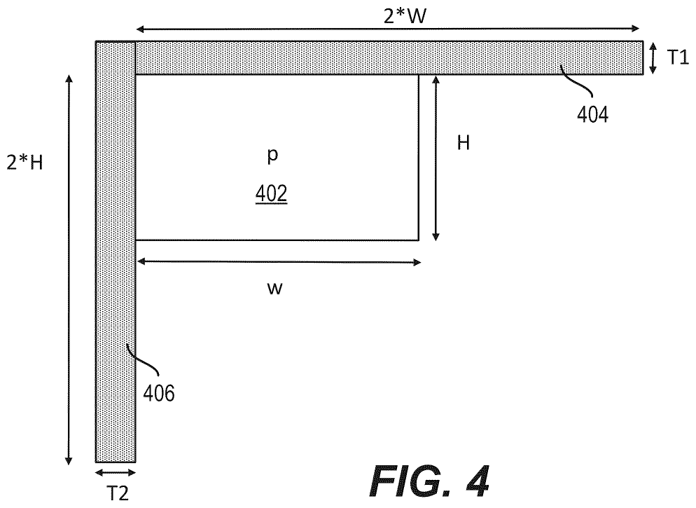

In a second method, for some of the intra prediction modes, an intra prediction signal may be generated by using reference samples multiplied with coefficients (e.g., weight coefficients). The weighted coefficients may be trained offline and stored as a matrix. FIG. 4 shows an example of the training-based prediction. As shown in FIG. 4, a current prediction block (402) includes reference samples (404) at a top side of the current prediction block (402) and reference samples (406) at a left side of the current prediction block (402). W and H represent a width and a height of the current prediction block (402) respectively. In an example, the reference samples (404) on the top side may have a double-sized width and the reference samples (406) at the left side may have a double-sized height. In an example, the reference samples (404) may have a total number of sample lines T1 and the reference samples (406) may have a total number of sample lines T2. In an example, prediction signal of the current prediction block (402) is given by equation (1) as follows:

$$P ( x , y ) = {\sum }_{k} F ( x , y , k ) * r ( k ) , \qquad Eq . ( 1 )$$

where F(x, y, k) are trained coefficients (or weight coefficients) and r(k) are considered reference samples. (x, y) represents coordinates within the current prediction block (402), and k is an iterator going through all reference samples, such as the reference samples (404) and (406). A final predictor P(x,y) is a weighted sum of all reference samples according to equation (1).

In the second method, no signaling overhead may be introduced. Because a pre-defined sub-set of the intra modes in the first method is replaced with the matrix-multiplication based approach according to the second method. In other words, some conventional intra modes are instituted by the matrix-multiplication based method.

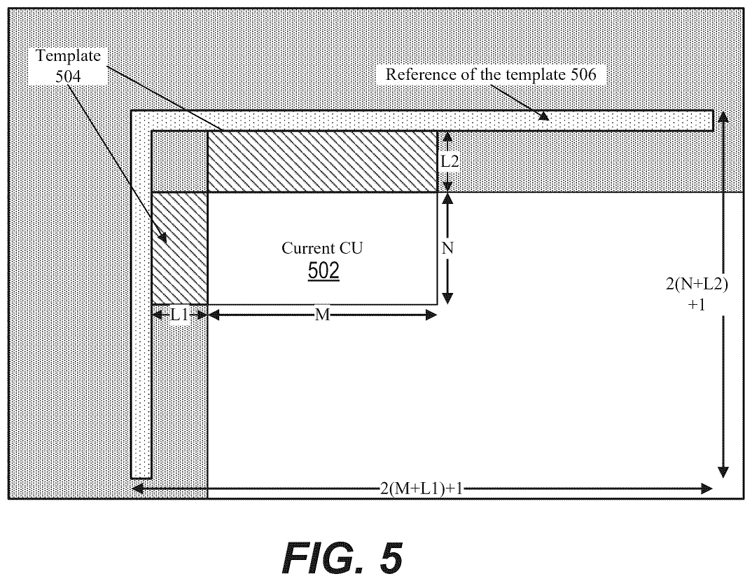

In a third method, template-based intra prediction mode derivation (TIMD) may be applied on a current coding block. When a template and the current coding block are well correlated, an intra prediction mode applied for the template may give a good indication for the current coding block. An example of an intra mode derivation using the template is summarized in steps as follows:
(1) As shown in FIG. 5, a current CU (502) include a template (504). A group of samples are defined as a reference (506) of the template (504). The samples in the reference (506) are used as reference samples to generate prediction signal of the template (504).
(2) An intra prediction mode is exercised on the reference (506) of the template (504) to generate a prediction signal of the template (504).
(3) Cost (e.g., sum of absolute transformed differences (SATD)) between the prediction signal and a reconstruction signal of the template (504) is calculated.
(4) Step (2) and (3) are repeated for other modes in a pre-defined intra prediction mode set and the pre-defined intra modes sorted based on their SATD costs.
(5) An intra mode with a least SATD cost is chosen as a prediction mode for the current block (502). An intra mode with a second least SATD cost is chosen as a secondary prediction mode for the current block (502). These two modes may be named as a primary template-based intra mode and a secondary template-based intra mode.
(6) Depending on the SATD costs of the primary and secondary template-based intra modes, a final predictor may be a fusion of two predictors based on the primary and secondary template-based intra modes, or a fusion of the two predictors plus a non-angular predictor (e.g., a planar prediction), or defined as a predictor by applying the primary template-based intra mode without fusion.

Aspects of the disclosure include a fused intra prediction mode, where a prediction signal is a fusion of at least two predictors. Among the at least two predictors, at least one predictor is generated by a training-based matrix-multiplication approach, such as the pre-trained matrix-multiplication based method according to the second method.

In an aspect, two predictors are applied for fusion and both the predictors are generated based on the matrix-multiplication methods.

In an example, the two predictors based on the matrix-multiplication methods are chosen based on template costs, and two predictors with the minimum template cost or minimum template costs are chosen for fusion.

In an example, a plurality of matrix-multiplication methods is applied to the reference (506) of the template (504) to obtain a plurality of predictors for the template (504). Each of the plurality of matrix-multiplication methods may include a respective set of trained coefficients F (x, y, k). A plurality of template costs may be obtained between the plurality of predictors for the template (504) and the reconstructed value of the template (504). Two matrix-multiplication methods may be selected from the plurality of matrix-multiplication methods. The selected two matrix-multiplication methods may correspond to two minimum cost values. The selected two matrix-multiplication methods may further be applied to the template (504) to generate the two predictors of the current block (502) according to equation (1).

In an aspect, two predictors are applied for fusion and one of the two predictors is generated by a conventional directional mode (e.g., an angular mode) or a non-directional mode (e.g., a planar mode or a DC mode), while the other predictor is generated based on a matrix-multiplication method, such as the matrix-multiplication method according to equation (1).

In an example, the two predictors are chosen based on template costs, and two predictors with the minimum template cost or costs are chosen for fusion. For example, a plurality of intra prediction modes is applied to the reference (506) of the template (504) to obtain a plurality of predictors for the template (504). The plurality of intra prediction modes may include matrix-multiplication methods and conventional prediction modes (e.g., directional or non-directional modes). A plurality of template costs may be obtained between the plurality of predictors for the template (504) and the reconstructed value of the template (504). Two intra prediction modes may be selected from the plurality of intra prediction methods. The two intra prediction modes may include a conventional intra prediction mode (e.g., a directional mode or a non-directional mode) and a matrix-multiplication method. The selected two intra prediction modes may correspond to two minimum cost values. The selected two intra prediction modes may further be applied to neighboring samples of the current block (502) to generate the two predictors of the current block (502).

In an example, the two predictors are generated from one of conventional intra predictors in the pre-defined sub-set of intra modes in the first method that is to be substituted and a corresponding substitution intra mode is the matrix-multiplication method. For example, a first one of the two predictors is generated by a conventional intra prediction mode (e.g., a directional mode or a non-directional mode) and a second one of the two predictors is generated from a matrix-multiplication method. The matrix-multiplication method is applied to replace an initially assigned conventional intra prediction mode.

In an aspect, the at least two predictors are fused adaptively. In an example, N (N>2 or N≥2) predictors are considered to be fused. However, a final number of predictors used to fusion is smaller or equal to N. For those N predictors, a pre-defined threshold is used to filter un-qualified predictors. The threshold, for example, may be based on a minimum template cost among the N predictors.

In an aspect, the aforementioned intra prediction mode is signaled explicitly in a bitstream. For example, the intra prediction mode is signaled at one of a picture level, a subpicture level, a tile level, a slice level, a coding block level, and a unit level.

In an aspect, the pre-defined intra modes in the third method for ranking template costs include intra prediction modes that are substituted by the matrix-multiplication method in the second method. For example, a plurality of intra modes is applied to the reference (506) of the template (504) to obtain a plurality of predictors for the template (504). The plurality of intra prediction modes may include matrix-multiplication methods and conventional prediction modes (e.g., directional or non-directional modes). The matrix-multiplication methods may be substituted intra modes of initially defined conventional intra modes. A plurality of template costs may be obtained between the plurality of predictors for the template (504) and the reconstructed value of the template (504). The template costs may further be ranked.

In an example, the non-angular prediction in the third method is one of the substituted intra predictors using matrix-multiplication based method.

In an aspect, the proposed method aforementioned is applied conditionally based on other coding information.

In an example, the aforementioned method is applied when a size of a current block is smaller than a pre-defined value N (e.g., N is 1024 samples).

In an example, the aforementioned method is applied when a ratio of a width of a current block and a height of the current block is smaller than a pre-defined value R (e.g., R is 4).

In an example, the aforementioned method is applied when a width of a current block and/or a height of the current block is smaller than a pre-defined value W and/or a pre-defined value H (e.g., W=32, H=32).

In an example, the aforementioned method is applied when a template size (e.g., T1 and/or T2 shown in FIG. 4) meets a pre-defined size condition (e.g., the size T1=T2=2).

Aspects of the disclosure include deriving a pre-defined sub-set of instituted intra modes based on the second methods. For example, based on the matrix-multiplication based method, prediction signals are obtained. A pre-defined sub-set of intra modes is determined based on the prediction signals.

In an aspect, the pre-defined sub-set of instituted intra modes includes a planar mode.

In an aspect, the pre-defined sub-set of instituted intra modes includes a DC mode.

In an aspect, the pre-defined sub-set of instituted intra modes includes a mode (or angular mode) equal to (2+4*k). In an example, k=[0,16].

In an aspect, the pre-defined sub-set of instituted intra modes includes a mode (or angular mode) equal to (2+2*k), In an example, k=[0,32].

In an aspect, the pre-defined sub-set of instituted intra modes according to the second method are separated from conventional intra modes in the first method, and the pre-defined sub-set of instituted intra modes are signaled explicitly in a bitstream.

A hybrid video codec may include various coding modules, such as for intra prediction, inter prediction, transform coding, quantization, entropy coding, and post in-loop filtering. In an inter prediction coding, a final motion vector may either be derived based on spatial/temporal information or be a sum of a signalled motion vector difference and a derived or selected motion vector predictor. When a motion vector is to be derived based on spatial or temporal information, the motion vector can be derived from a motion vector of an adjacent neighbouring coded block, a non-adjacent neighbouring coded block, a collocated coded block in a reference picture, or a history-based motion information from a previous coded block. Positions of those coded blocks may be fixed and predefined during a merge candidate list construction.

A current coding block and neighboring samples of the current coding block may share similar texture characteristic. Thus, neighboring reconstructed samples, which can be called a template, may be employed to predict the current coding block. For inter prediction, template-matching is widely used to derive a prediction block by calculating a distortion between the template of the current block and the template of the prediction block in a reference picture. Moreover, template-matching may be applied in a reconstructed area of the current picture as well, namely intra template-matching.

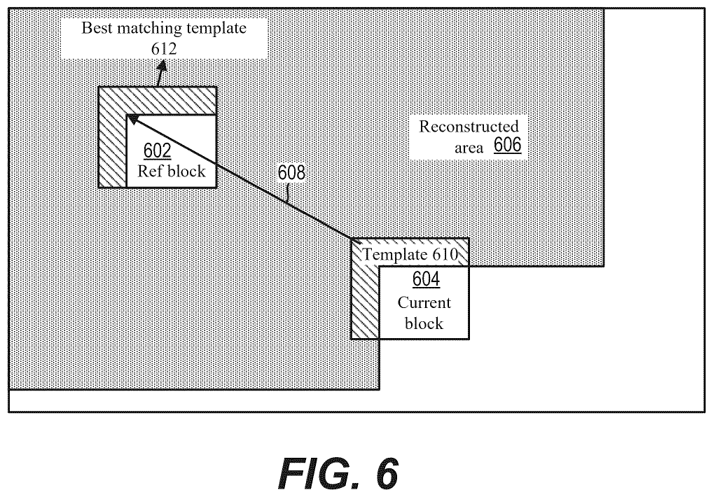

An example of intra template-matching may be shown in FIG. 6. As shown in FIG. 6, a prediction block (or reference block) (602) for a current block (604) can be derived from a reconstructed area (606) with a block vector (BV) (608). The block vector (608) is derived by calculating template-matching with a smallest distortion between a template (610) of the current block (604) and a template (612) of the prediction block (602). The current block (604) may be copied from the reference block (602) or derived by applying a filter on reference block (602).

Intra template matching (named as Method A in the current disclosure) is one of a plurality of intra prediction methods. It is different from a conventional intra prediction approach (Method B in the current disclosure), in which a current block is predicted from neighboring reference samples. Within the conventional intra prediction approach, intra mode indicates some angular characteristics of a prediction block. In an example, the angular characteristics are explicitly signaled by pre-defined syntax in a bitstream.

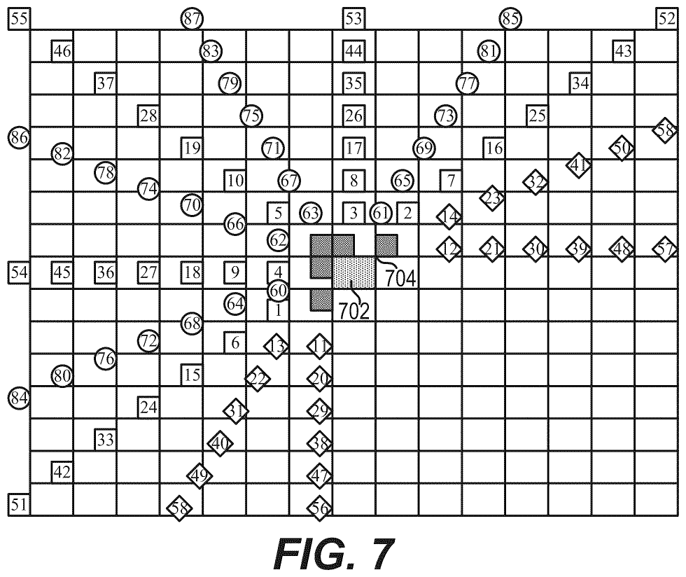

In a third method (method C in the disclosure), a current block may inherit intra prediction mode from merge candidates in neighboring areas (e.g., either adjacent blocks or non-adjacent blocks). FIG. 7 shows an example of a plurality of merge candidate positions for intra prediction mode inheritance. As shown in FIG. 7, the merge candidate positions include a first group of pre-defined merge candidates positioned along an angle of πk/8 with respect to a horizontal axis, where k is an integer, such as an integer from 0 to 12. The merge candidate positions may also include a second group of pre-defined merge candidates positioned at an upper right corner (704), an upper left corner, and a lower-left corner of a current block (702). In an example, the merge candidates in the second group have a higher priority than the merge candidates in the first group. In an example, priorities of the merge candidates in the first group are indicated by numbers assigned to the merge candidates shown in FIG. 7.

In an aspect of the disclosure, the intra prediction mode information is not limited to the conventional intra prediction mode as defined in method B. It may also include other non-conventional intra prediction method, such as a decoder-side intra mode derivation, a template-matching based intra prediction mode, or a training-based matrix-multiplication approach.

Aspects of the disclosure including applying template matching (method A) in a pre-defined area to improve the pre-defined merge candidate positions in method C. In an example, the pre-defined area may cover or surpass the area shown in FIG. 7.

In an aspect, the pre-defined area for template matching covers all pre-defined positions in method C that is shown in FIG. 7.

In an aspect, template matching is used to refine a position of a pre-defined merge candidate. In an example, the refinement is performed by comparing template costs within a pre-defined refinement window. In an example, a refinement window N×M (N and M is larger than zero) is defined for a pre-defined merge candidate at a fixed position in method C. The start/original position for the refinement corresponds to an offset (N/2, M/2).

In an example, a merge candidate position is selected as one of the merge candidate positions shown in FIG. 7. The selected merge candidate position is further refined according to intra template matching shown in FIG. 6. For example, a refinement window that includes a plurality of refinement positions is determined based on the selected merge candidate position. A plurality of candidate templates is defined in the refinement window. A plurality of templating matching (TM) costs is calculated based on the candidate templates and the template of the current block. The selected merge candidate position is replaced by one of the refinement positions that corresponds to a minimum TM cost of the TM costs.

FIG. 8 shows an example of refinement of pre-defined merge candidates at pre-defined positions. For example, as shown in FIG. 8, based on the refinement, original pre-defined merge candidate positions 10 and 19 in method C are re-positioned to 10′ and 19′ respectively.

In an aspect, template matching is used to cluster different pre-defined positions into one. The merging of different pre-defined positions may help reduce duplicate candidates for intra mode inheritance.

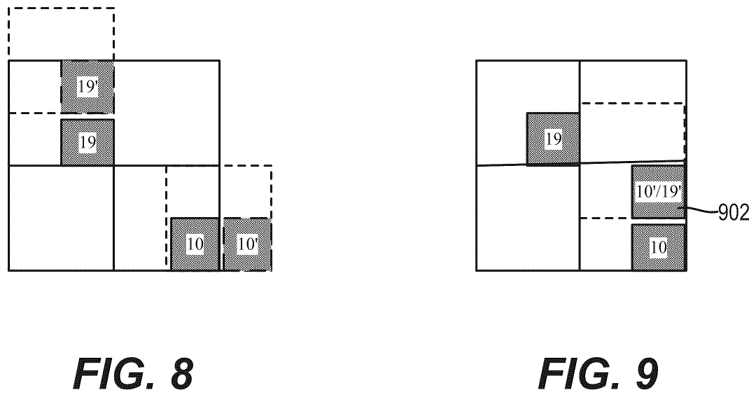

FIG. 9 shows an example of merging different pre-defined positions. As shown in FIG. 9, original pre-defined merge candidate positions 10 and 19 are refined into an overlapped position (902). Thus, after the refinement, the candidate positions 10 and 19 are considered as one position disposed at the overlapped position (902).

In an example, when an overlapped area of refined positions between two or more merge candidates surpasses a threshold, the two or more merged candidates are considered as one position.

In an aspect, a list of merge candidates is derived by template matching method in a pre-defined area. These new merge candidates in the list are compared with merge candidates at pre-defined positions in method C. Finally, an updated merge candidates list is derived.

In an example, the pre-defined area may surpass the area defined in method C. For example, more areas are searched by the template matching method than the area shown in FIG. 7. In an example, template-matching method searches for the best N blocks (or N reference blocks) with least N costs in the pre-defined area and puts the best N blocks into an intermediate list.

In an example, only these N new merge candidates in the intermediate list are compared with the merge candidates at pre-defined positions, such as the pre-defined positions shown in FIG. 7. In an example, a new merge candidate in the list is considered as a refinement merge candidate to replace a pre-defined merge candidate at a fixed position when these two candidates are within a refinement window. For example, as shown in FIG. 8, a new merge candidate indicated by the position 19′ and a pre-defined merge candidate indicated by the position 19 are within a same refinement window. Thus, the pre-defined merge candidate 19 is replaced by the new merge candidate 19′. In an example, a new merge candidate in the list is considered as an additional merge candidate when a distance between the new merge candidate and a merge candidate at a fixed position is larger than a refinement window.

In an aspect, a new merge candidate intra mode is derived for a current block by template matching at specific positions of a reference block of the current block. For example, based on the fixed positions shown in FIG. 7, a reference block is defined for a current block. A new merge candidate intra mode is further derived by template matching at specific positions of the reference block.

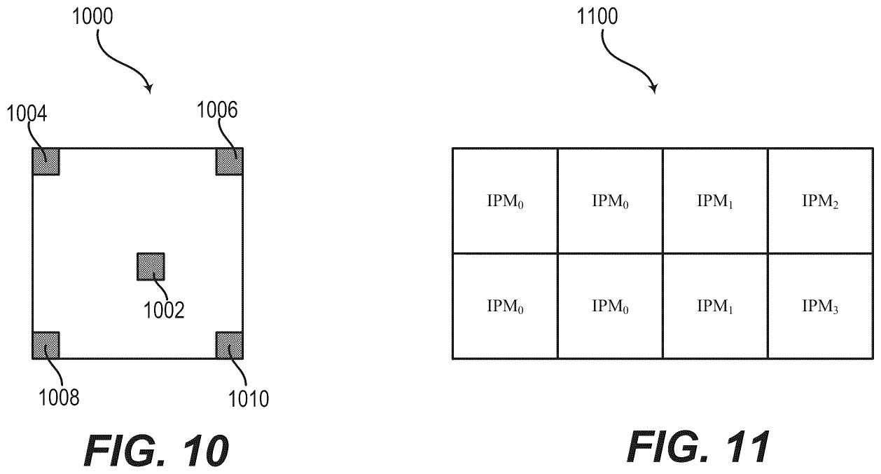

FIG. 10 shows an example of specific positions of a reference block of a current block. As shown in FIG. 10, a reference block (1000) may be determined according to merge candidates shown in FIG. 7 or according to intra template-matching shown in FIG. FIG. 6. An intra mode is derived from one of five pre-defined positions in the reference block (1000). The five pre-defined positions include a center (1002), a top-left (1004), a top-right (1006), a bottom-left (1008), and a bottom-right (1010) of the reference block (1000). In an example, a plurality of template matching costs may be calculated based on templates at the specific positions and a template of the current block. A position in the five pre-defined positions that corresponds to a minimum template matching cost is selected. An intra mode indicated by the selected position is further applied to the current block for prediction. For example, an intra mode of the current block is inherited from the intra mode associated with the selected position.

In an example, as shown in FIG. 10, whether the intra mode is available for the center position (1002) at [W/2, H/2] is determined. If the intra mode at the center position (1002) is not available, intra mode information at four corners is determined in a pre-defined order, such as a clockwise order, starting from the top left position (1004).

In an aspect, when a reference block is found, such as by the template-matching approach shown in FIG. 6, an intra mode of the reference block is derived as a most frequent mode within the found reference block. In an example, when a size of a reference block is larger than a threshold size, such as a minimum intra prediction block size, the reference block may be partitioned into a plurality of subblocks. An intra mode may be derived for each of the subblocks. For example, the intra mode is derived based on the intra template matching in a refinement window of each of the subblocks. An intra mode of the reference block may be determined as a most frequent mode of the intra modes derived for the subblocks.

As shown in FIG. 11, a reference block (1100) may have a size of 16×8. When a minimum intra prediction block size is 4×4, the reference block (1100) may be divided into a (16/4)×(8/4)=4×2 grids (also referred to as grid cells or subblocks). For each grid cell, an intra mode is derived and a most frequent intra mode (IPMO) within the grids is chosen as the intra mode for the found reference block (1100).

In an aspect, the template-matching cost applied in the current disclosure may be but is not limited to sum of absolute differences (SAD), sum of absolute transformed differences (SATD), sum of squared errors (SSE), or the like.

In an aspect, the search area of the intra template-matching is within an entire reconstructed current picture.

In an aspect, a search range restriction may be applied to the intra template-matching applied in the current disclosure. For example, the search range may be restricted within a search range with a fixed size, within a current CTU row, within a current CTU row, or within N previous coded CTU row(s).

In an aspect, different template-matching types may be used for intra template-matching process. In an example, only a left template, a top template, or a top-left template is used. In an example, for smaller blocks (e.g., a block is smaller than or equal to a threshold value, such as 64), a template with a first size (e.g., 2 lines) is applied. For another case (e.g., a block is larger than the threshold value), a template with a second size (e.g., 4 lines) is applied. In an example, different template-matching types may be used adaptively at a block level and a syntax may be signaled to indicate which template type is used.

In an aspect, when an intra merge candidate list contains one or more intra merge candidates, an intra merge flag and/or an index may be signaled to indicate a selected candidate.

In an aspect, intra merge candidates may contain one or more intra prediction information. The one or more intra prediction information may include an intra prediction mode, a filter parameter, a block vector, etc.

As noted above, emerging image and video coding standards may follow a hybrid framework. A hybrid video coding framework may include one or more of the various modules of the hybrid video codec. In video codecs, such as VVC and ECM, an intra prediction may effectively help to reduce long-range correlations. Various intra prediction modes, such as angular mode, MIP mode, DIMD mode, and TIMD mod, have been applied to achieve better prediction.

Aspects of the current disclosure include a spectrum domain-based intra prediction mode. The spectrum domain-based intra prediction mode serve as a supplementary mode to a planar mode, for example.

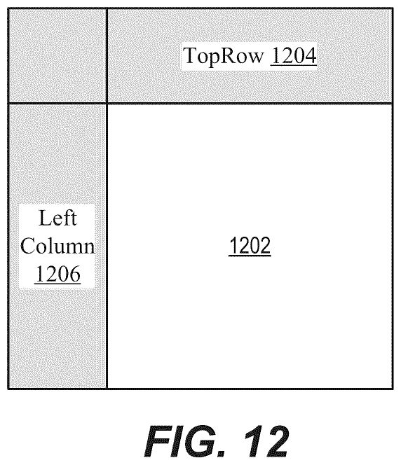

In an aspect, the spectrum domain-based intra prediction mode may be conducted based on neighboring samples of a current block. In an example shown in FIG. 12, a current block (1202) may include neighboring samples in reference lines, such as in a reference row topRow at a top side of the current block and in a reference column leftColumn at a left side of the current block. In an example, the reference row or the reference column is a one-dimensional (1D) reference region with one pixel larger than a target prediction region of the current block (1202).

In an aspect, the spectrum domain-based intra prediction mode may be conducted based on steps as follow:

Step 1: One-dimensional spatial to spectrum transform is applied on both reference arrays (e.g., the topRow and the leftColumn) to decorrelate reference pixel values in the reference arrays. The spatial to spectrum transform may refer to a process of converting information from a spatial domain (like an image or a video) into a frequency domain (a spectrum). In an example, the one-dimensional spatial to spectrum transform may be conducted by discrete cosine transform type-II (DCT-2) algorithm, discrete Fourier transform (DFT), fast Fourier transform (FFT), or the like.

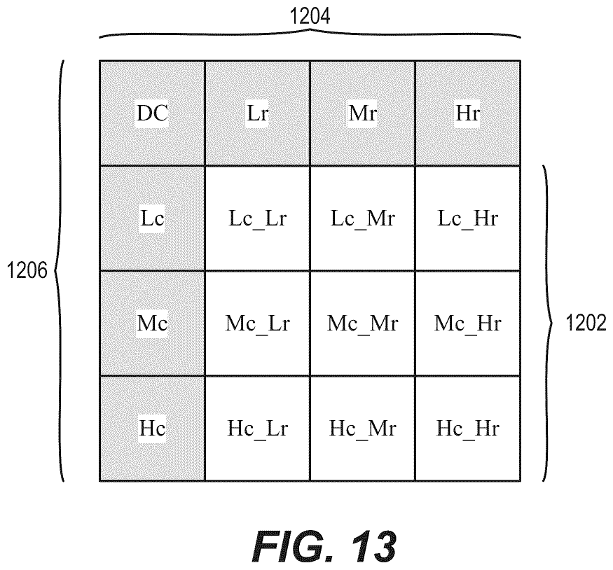

Step 2: Spectrum coefficients generated by the one-dimensional spatial to spectrum transform may be put back to positions of the reference pixels in the reference arrays. In an aspect, the spectrum coefficients may refer to numerical values that represent strengths or amplitudes of different frequency components within a spectrum. As shown in FIG. 13, a plurality of spectrum coefficients is put back to the reference row toprow and the reference column leftColumn. In the plurality of spectrum coefficients, DC (or DC coefficient) represents a mean of pixel values of a reference line, and LIM/H represents low/middle/high frequencies of the transformed coefficients for the reference lines.

Step 3: A target prediction position (y,x) in the current block (1202) may be filled by considering both spectrum coefficients from (y,0) and (0,x) in the reference lines leftColumn and topRow. In an example, a position (1,2) in the current block (1202) may consider Lc and Mr to derive a combined frequency value Lc_Mr.

Step 4: An inverse transform may be applied on a 2D block. The inverse transform may be aligned with the transform on the reference lines. The 2D block may include the current block (1202) and the reference lines (1204) and (1206). In an example, a prediction signal may be obtained after the inverse transform. In an example, both reference lines leftColumn and topRow may use a same transform algorithm, such as DCT-2, in Step 1. Then a 2D inverse transform, such as an inverse DCT-2, may be performed on the 2D block after all positions of the 2D block have been filled with the corresponding values (e.g., transform coefficients).

Step 5: A prediction block of the current block (1202) may be derived from removing prediction information of the reference lines.

In an aspect, reference lines may be larger than a height or a width of a target prediction block. Steps 1 through 4 may be conducted to generate an inverse transform block that includes prediction information of the reference lines and the target prediction block. Further, the target prediction block may be derived by cropping its corresponding positions from the inverse transformed block.

In an aspect, the reference lines topRow and leftColumn may have different DC coefficients, and the two DC coefficients may be merged into one, such as a merged DC. In an example, the merged DC may be a mean of DC coefficients from both reference lines. In an example, the merged DC may be a geometric mean of DC coefficients from both reference lines. In an example, two DCs from both reference lines may be merged based on information of the reference lines.

In an aspect, the two frequency coefficients from the reference lines may be merged to one by a geometric mean of the corresponding coefficients in the reference lines. In an example, a transform coefficient in a position (1,2) Lc_Mr=sqrt(Lc*Mr).

In an aspect, two frequency coefficients from the reference lines may be merged into one based on the information from the reference lines.

In an aspect, a final inverse transformed block may be obtained by adjusting magnitudes of the inverse transformed block obtained at step 4 based on prediction values and actual pixel values of the reference lines. In an example, a predicted value within the inverse transformed block may be adjusted using a regression formula, such as a*Val+b, where a and b may be constants learned from the actual pixel values of the reference lines and the corresponding prediction values. In an example, the predicted value may be adjusted by other regression methods with parameters learned from the actual pixel values of the reference lines and the corresponding prediction values.

In an aspect, different 1D spatial to spectrum transforms may be applied on the reference lines topRow and leftColumn. When a 2D inverse transform is conducted, transform on the topRow may be considered as a horizontal transform and transform on the leftColumn may be considered as a vertical transform. A two-stage inverse transform may be conducted based on the horizontal transform and the vertical transform to get back to the spatial domain that includes reconstructed samples of the reference lines and the current block.

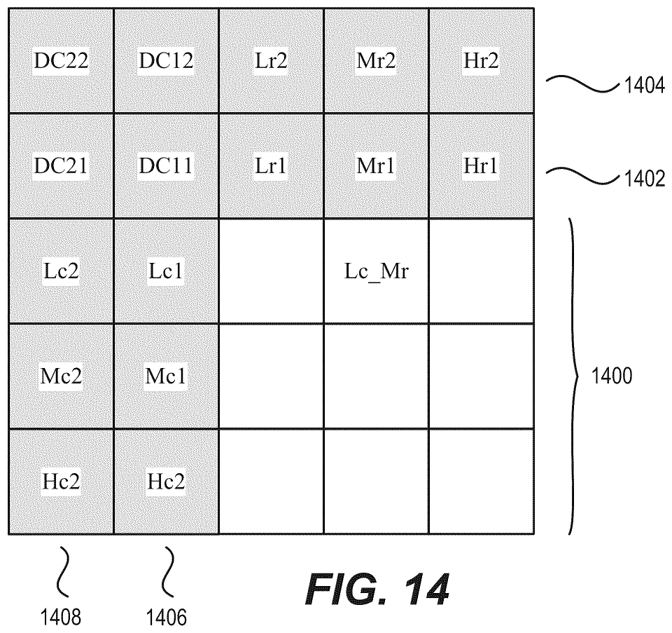

In an aspect, as shown in FIG. 14, multiple reference lines may be applied to conduct the spectrum domain-based intra prediction mode. FIG. 14 shows two reference rows (1402) and (1404) and two reference columns (1406) and (1408). As shown in FIG. 14, 1D transform may be performed on each reference line respectively. Spectrum coefficients in a prediction region of a current block (1400) may be a combination of reference spectrum coefficients in a same row and/or column. In an example, a transform coefficient in a position (1,2) Lc_Mr may be a combination of Lc1, Lc2, Mr1, and Mr2 coefficients from the four reference lines (1402), (1404), (1406), and (1408). In an example, the reference rows and the reference columns may have a same transform type. In an example, one type of transform may be applied to the reference rows, while another type of transform may be applied to the reference columns.

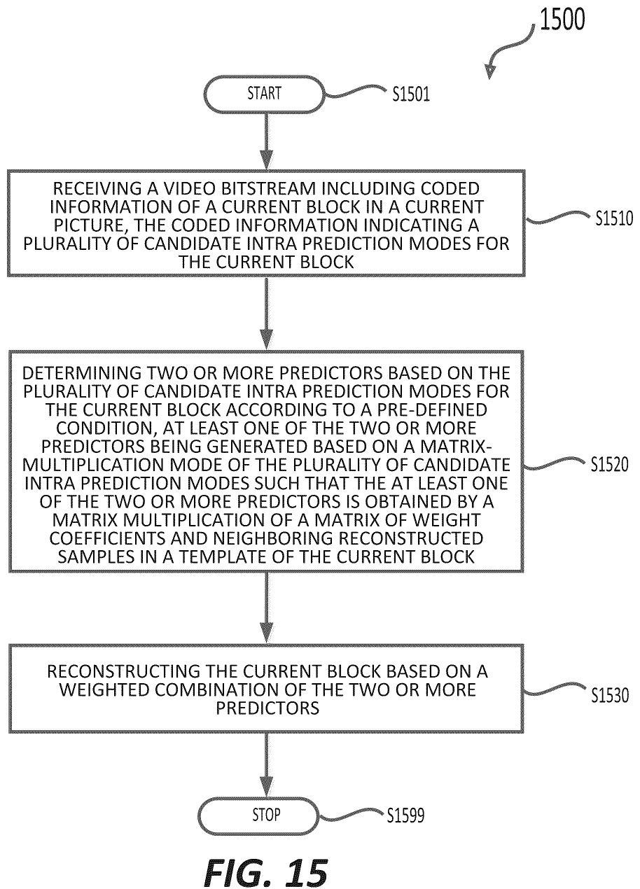

FIG. 15 shows a flow chart outlining a process (1500) according to an aspect of the disclosure. The process (1500) can be used in a video decoder. In various aspects, the process (1500) is executed by processing circuitry, such as the processing circuitry that performs functions of the video decoder (110), the processing circuitry that performs functions of the video decoder (210), and the like. In some aspects, the process (1500) is implemented in software instructions, thus when the processing circuitry executes the software instructions, the processing circuitry performs the process (1500). The process starts at (S1501) and proceeds to (S1510).

At (S1510), a video bitstream including coded information of a current block in a current picture is received. The coded information indicates a plurality of candidate intra prediction modes for the current block.

At (S1520), two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block.

At (S1530), the current block is reconstructed based on a weighted combination of the two or more predictors.

In an aspect, the plurality of candidate intra prediction modes is applied to reference samples of the template of the current block to generate a plurality of prediction values of the template. A plurality of cost values between each of the plurality of prediction values and a reconstructed value of the template is determined. The two or more predictors are determined based on two or more candidate intra prediction modes of the plurality of candidate intra prediction modes that correspond to cost values of the plurality of cost values larger than a threshold value.

In an aspect, the two or more predictors are two predictors that are generated by the matrix-multiplication mode. A first one of the two predictors is obtained by a first matrix multiplication of a first matrix of weight coefficients and the neighboring reconstructed samples of the template. A second one of the two predictors is obtained by a second matrix multiplication of a second matrix of weight coefficients and the neighboring reconstructed samples of the template.

In an aspect, the two or more predictors are two predictors. A first one of the two predictors is generated by the matrix-multiplication mode. A second one of the two predictors is generated by one of an angular mode, a planar mode, and a DC mode.

In an aspect, the pre-defined condition includes one of (i) a size of the current block is smaller than a pre-defined value, (ii) a ratio between a width of the current block and a height of the current block is smaller than a pre-defined value, (iii) the width of the current block and the height of the current block is smaller than a pre-defined value, and (iv) a size of the template is equal to a pre-defined size.

In an aspect, the plurality of candidate intra prediction modes includes one of a planar mode, a DC mode, a mode equal to (2+4×K) when K is constrained to an integer from 0 to 16, and a mode equal to (2+2×K) when K is constrained to an integer from 0 to 32.

Then, the process proceeds to (S1599) and terminates.

The process (1500) can be suitably adapted. Step(s) in the process (1500) can be modified and/or omitted. Additional step(s) can be added. Any suitable order of implementation can be used.

The present disclosure includes aspects related to a video encoder. In an example, a plurality of candidate intra prediction modes is determined for a current block in a current picture. Two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The current block is encoded into a bitstream based on a weighted combination of the two or more predictors.

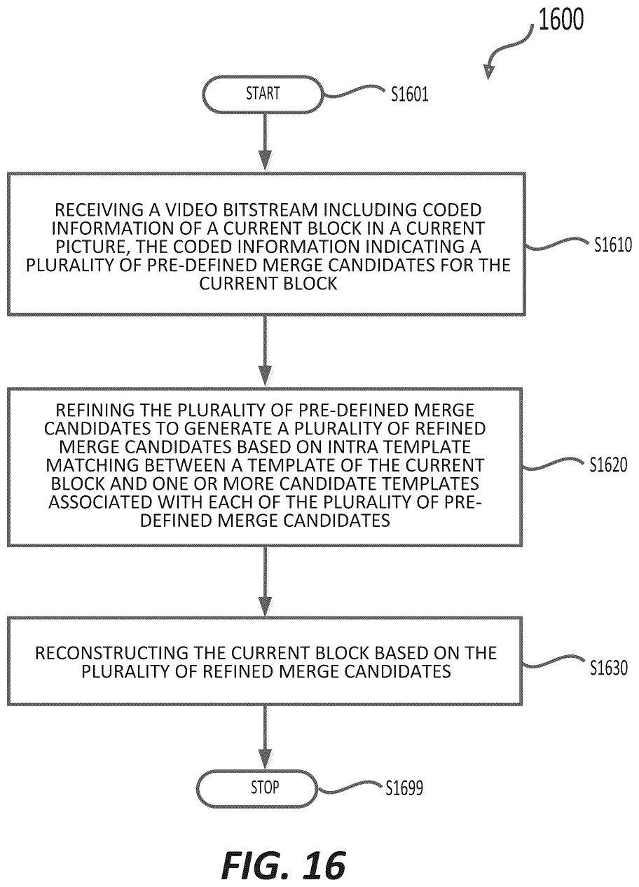

FIG. 16 shows a flow chart outlining a process (1600) according to an aspect of the disclosure. The process (1600) can be used in a video decoder. In various aspects, the process (1600) is executed by processing circuitry, such as the processing circuitry that performs functions of the video decoder (110), the processing circuitry that performs functions of the video decoder (210), and the like. In some aspects, the process (1600) is implemented in software instructions, thus when the processing circuitry executes the software instructions, the processing circuitry performs the process (1600). The process starts at (S1601) and proceeds to (S1610).

At (S1610), a video bitstream including coded information of a current block in a current picture is received. The coded information indicates a plurality of pre-defined merge candidates for the current block.

At (S1620), the plurality of pre-defined merge candidates is refined to generate a plurality of refined merge candidates based on intra template matching between a template of the current block and one or more candidate templates associated with each of the plurality of pre-defined merge candidates.

At (S1630), the current block is reconstructed based on the plurality of refined merge candidates.

In an aspect, the plurality of pre-defined merge candidates includes (i) a first group of pre-defined merge candidates positioned along an angle of πk/8 with respect to a horizontal axis, k being an integer from 0 to 12, and (ii) a second group of pre-defined merge candidates positioned at an upper right corner, an upper left corner, and a lower-left corner of the current block.

In an aspect, a refinement window associated with a first one of the plurality of pre-defined merge candidates is determined. One or more candidate templates in the refinement window are determined. One or more templating matching (TM) costs are calculated based on the one or more candidate templates and the template of the current block. A first one of the plurality of refined merge candidates that corresponds to a minimum TM cost of the one or more TM costs is determined.

In an aspect, two or more of the plurality of refined merge candidates are merged when an overlapped area of the two or more of the plurality of refined merge candidates is larger than a threshold.

In an aspect, a merge candidate list is derived based on the plurality of pre-defined merge candidates and the plurality of refined merge candidates. In an example, a first pre-defined merge candidate of the plurality of pre-defined merge candidates is replaced with a first refined merge candidate of the plurality of refined merge candidates when the first pre-defined merge candidate and the first refined merge candidate are within a refinement window. In an example, both the first pre-defined merge candidate and the first refined merge candidate are kept when a distance between the first pre-defined merge candidate and the first refined merge candidate is larger than the refinement window.

In an aspect, one or more refinement positions associated with a first pre-defined merge candidate of the plurality of pre-defined merge candidates are determined. The one or more refinement positions include one of a top-right corner, a top-left corner, a bottom-left corner, and a bottom-right corner of the first pre-defined merge candidate. One or more candidate templates are determined at the one or more refinement positions. One or TM costs are calculated based on the one or more candidate templates and the template of the current block. A first refined merge candidate of the plurality of refined merge candidates that corresponds to a minimum TM cost of the one or more TM costs is determined.

In an aspect, when a first refined merge candidate of the plurality of refined merge candidates has a size larger than a threshold size, the first refined merge candidate is partitioned into a plurality of sub-blocks based on the threshold size. An intra prediction mode is derived for each of the plurality of sub-blocks. The first refined merge candidate is updated as a most frequent one of the derived intra prediction modes.

In an aspect, the template of the current block has a size of 2 lines of neighboring samples when a size of the current block is equal to or less than a threshold value, and the template of the current block has a size of 4 lines of neighboring samples when the size of the current block is larger than a threshold value.

Then, the process proceeds to (S1699) and terminates.

The process (1600) can be suitably adapted. Step(s) in the process (1600) can be modified and/or omitted. Additional step(s) can be added. Any suitable order of implementation can be used.

The present disclosure includes aspects related to a video encoder. In an example, a plurality of pre-defined merge candidates is determined for a current block in a current picture. The plurality of pre-defined merge candidates is refined to generate a plurality of refined merge candidates based on intra template matching between a template of the current block and one or more candidate templates associated with each of the plurality of pre-defined merge candidates. The current block is encoded into a bitstream based on the plurality of refined merge candidates.

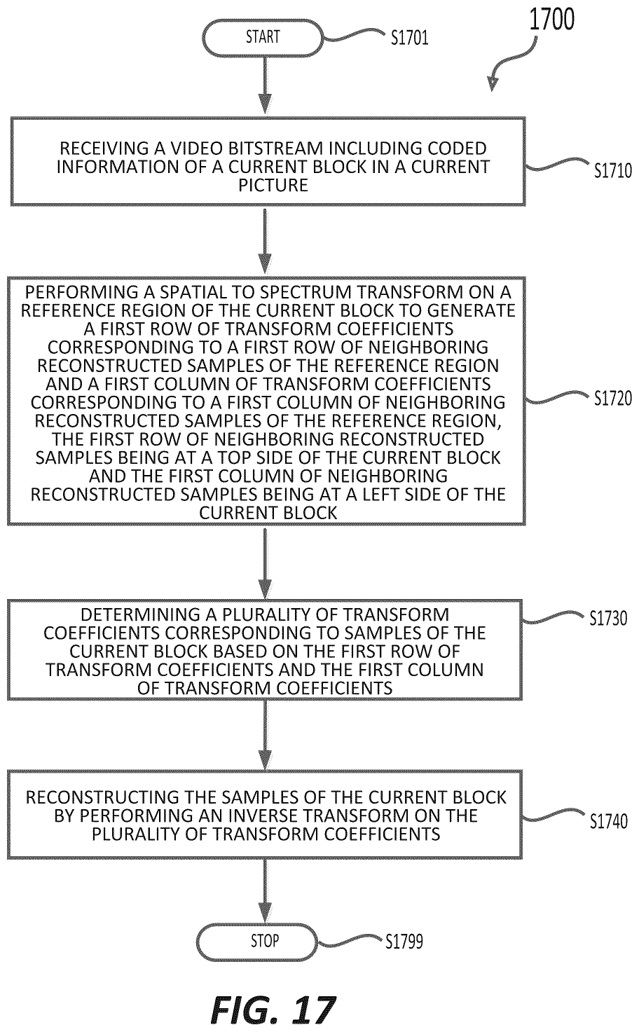

FIG. 17 shows a flow chart outlining a process (1700) according to an aspect of the disclosure. The process (1700) can be used in a video decoder. In various aspects, the process (1700) is executed by processing circuitry, such as the processing circuitry that performs functions of the video decoder (110), the processing circuitry that performs functions of the video decoder (210), and the like. In some aspects, the process (1700) is implemented in software instructions, thus when the processing circuitry executes the software instructions, the processing circuitry performs the process (1700). The process starts at (S1701) and proceeds to (S1710).

At (S1710), a video bitstream including coded information of a current block in a current picture is received.

At (S1720), a spatial to spectrum transform is performed on a reference region of the current block to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block.

At (S1730), a plurality of transform coefficients corresponding to samples of the current block is determined based on the first row of transform coefficients and the first column of transform coefficients.

At (S1740), the samples of the current block are reconstructed by performing an inverse transform on the plurality of transform coefficients.

In an aspect, each of the plurality of transform coefficients is determined based on (i) one of the first row of transform coefficients that has a same horizontal coordinate as the respective one of the plurality of transform coefficients and (ii) one of the first column of transform coefficients that has a same vertical coordinate as the respective one of the plurality of transform coefficients.

In an aspect, a first DC coefficient of the first row of transform coefficients corresponding to a neighboring sample at a top-left corner of the current block is determined. A second DC coefficient of the first column of transform coefficients corresponding to the neighboring sample at the top-left corner of the current block is determined. The first DC coefficient and the second DC coefficient are overlapped. The first DC coefficient and the second DC coefficient are merged to obtain a DC coefficient corresponding to the neighboring sample at the top-left corner of the current block.

In an aspect, each of the plurality of transform coefficients is determined by merging (i) one of the first row of transform coefficients that has a same horizontal coordinate as the respective one of the plurality of transform coefficients and (ii) one of the first column of transform coefficients that has a same vertical coordinate as the respective one of the plurality of transform coefficients.

In an aspect, the inverse transform is performed on the plurality of transform coefficients corresponding to the samples of the current block to generate a plurality of initial prediction samples of the current block. Each of plurality of initial prediction samples is adjusted by a regression formula to obtain a plurality of prediction samples of the current block. The regression formula is equal to a×Val+b. Val is the respective one of the plurality of initial prediction samples. a and b are constants determined from samples of the reference region and prediction samples of the reference region. The current block is reconstructed based on the plurality of prediction samples of the current block.

In an aspect, the reference region further includes a second row of neighboring reconstructed samples at a top side of the first row of neighboring reconstructed samples and a second column of neighboring reconstructed samples at a left side of the first column of neighboring reconstructed samples.

Then, the process proceeds to (S1799) and terminates.

The process (1700) can be suitably adapted. Step(s) in the process (1700) can be modified and/or omitted. Additional step(s) can be added. Any suitable order of implementation can be used.

The present disclosure includes aspects related to a video encoder. In an example, a spatial to spectrum transform is performed on a reference region of a current block in a current picture to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block. A plurality of transform coefficients corresponding to samples of the current block is determined based on the first row of transform coefficients and the first column of transform coefficients. The samples of the current block are encoded by performing an inverse transform on the plurality of transform coefficients.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a bitstream of the visual media data is processed according to a format rule. The bitstream includes coded information of a current block in a current picture. The coded information indicates a plurality of candidate intra prediction modes for the current block. The format rule specifies that two or more predictors are determined based on the plurality of candidate intra prediction modes for the current block according to a pre-defined condition. At least one of the two or more predictors is generated based on a matrix-multiplication mode of the plurality of candidate intra prediction modes such that the at least one of the two or more predictors is obtained by a matrix multiplication of a matrix of weight coefficients and neighboring reconstructed samples in a template of the current block. The format rule specifies that the current block is processed based on a weighted combination of the two or more predictors.

In an example, a bitstream of the visual media data is processed according to a format rule. The bitstream includes coded information of a current block in a current picture. The coded information indicates a plurality of pre-defined merge candidates for the current block. The format rule specifies that the plurality of pre-defined merge candidates is refined to generate a plurality of refined merge candidates based on intra template matching between a template of the current block and one or more candidate templates associated with each of the plurality of pre-defined merge candidates. The format rule specifies that the current block is processed based on the plurality of refined merge candidates.

In an example, a bitstream of the visual media data is processed according to a format rule. The bitstream includes coded information of a current block in a current picture. The format rule specifies that a spatial to spectrum transform is performed on a reference region of the current block to generate a first row of transform coefficients corresponding to a first row of neighboring reconstructed samples of the reference region and a first column of transform coefficients corresponding to a first column of neighboring reconstructed samples of the reference region. The first row of neighboring reconstructed samples is at a top side of the current block and the first column of neighboring reconstructed samples is at a left side of the current block. The format rule specifies that a plurality of transform coefficients corresponding to samples of the current block is determined based on the first row of transform coefficients and the first column of transform coefficients. The format rule specifies that the samples of the current block are processed by performing an inverse transform on the plurality of transform coefficients.

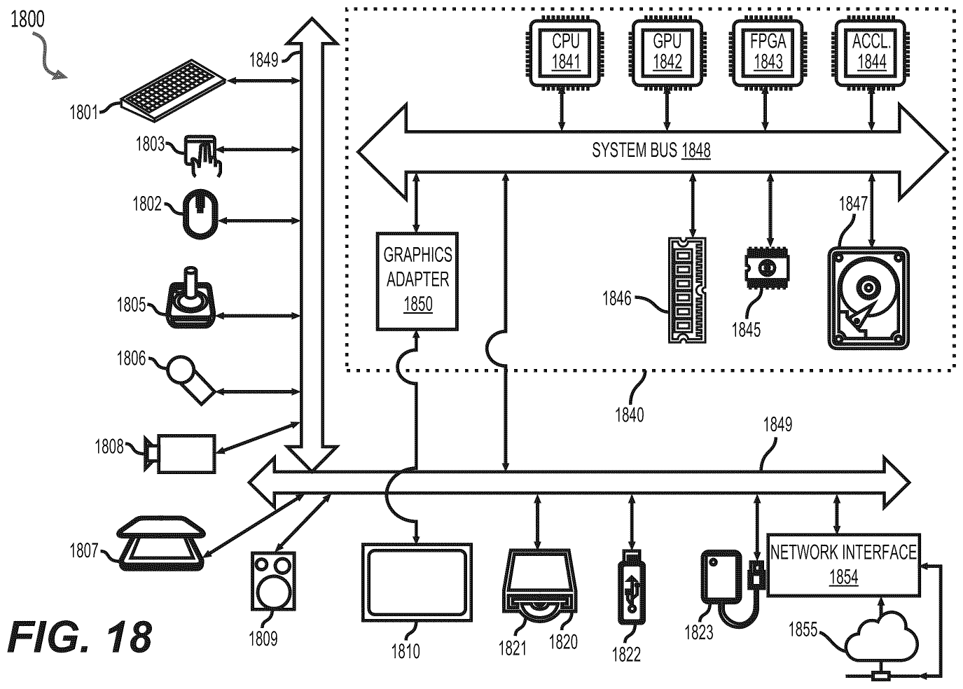

The techniques described above, can be implemented as computer software using computer-readable instructions and physically stored in one or more computer-readable media. For example, FIG. 18 shows a computer system (1800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 18 for computer system (1800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1800).

Computer system (1800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1801), mouse (1802), trackpad (1803), touch screen (1810), data-glove (not shown), joystick (1805), microphone (1806), scanner (1807), camera (1808).

Computer system (1800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1810), data-glove (not shown), or joystick (1805), but there can also be tactile feedback devices that do not serve as input devices), audio output devices (such as: speakers (1809), headphones (not depicted)), visual output devices (such as screens (1810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1800) can also include human accessible storage devices and their associated media such as optical media including CD/DVD ROM/RW (1820) with CD/DVD or the like media (1821), thumb-drive (1822), removable hard drive or solid state drive (1823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1800) can also include an interface (1854) to one or more communication networks (1855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1849) (such as, for example USB ports of the computer system (1800)); others are commonly integrated into the core of the computer system (1800) by attachment to a system bus as described below (for example Ethernet interface into a PC computer system or cellular network interface into a smartphone computer system). Using any of these networks, computer system (1800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1840) of the computer system (1800).

The core (1840) can include one or more Central Processing Units (CPU) (1841), Graphics Processing Units (GPU) (1842), specialized programmable processing units in the form of Field Programmable Gate Areas (FPGA) (1843), hardware accelerators for certain tasks (1844), graphics adapters (1850), and so forth. These devices, along with Read-only memory (ROM) (1845), Random-access memory (1846), internal mass storage such as internal non-user accessible hard drives, SSDs, and the like (1847), may be connected through a system bus (1848). In some computer systems, the system bus (1848) can be accessible in the form of one or more physical plugs to enable extensions by additional CPUs, GPU, and the like. The peripheral devices can be attached either directly to the core's system bus (1848), or through a peripheral bus (1849). In an example, the screen (1810) can be connected to the graphics adapter (1850). Architectures for a peripheral bus include PCI, USB, and the like.

CPUs (1841), GPUs (1842), FPGAs (1843), and accelerators (1844) can execute certain instructions that, in combination, can make up the aforementioned computer code. That computer code can be stored in ROM (1845) or RAM (1846). Transitional data can also be stored in RAM (1846), whereas permanent data can be stored for example, in the internal mass storage (1847). Fast storage and retrieve to any of the memory devices can be enabled through the use of cache memory, that can be closely associated with one or more CPU (1841), GPU (1842), mass storage (1847), ROM (1845), RAM (1846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1800), and specifically the core (1840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1840) that are of non-transitory nature, such as core-internal mass storage (1847) or ROM (1845). The software implementing various aspects of the present disclosure can be stored in such devices and executed by core (1840). A computer-readable medium can include one or more memory devices or chips, according to particular needs. The software can cause the core (1840) and specifically the processors therein (including CPU, GPU, FPGA, and the like) to execute particular processes or particular parts of particular processes described herein, including defining data structures stored in RAM (1846) and modifying such data structures according to the processes defined by the software. In addition or as an alternative, the computer system can provide functionality as a result of logic hardwired or otherwise embodied in a circuit (for example: accelerator (1844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of video decoding, the method including: receiving a video bitstream including coded information of a current block in a current picture, the coded information indicating a plurality of candidate intra prediction modes for the current block; determining two or more predictors based on the plurality of candidate intra prediction modes for the current block according to a pre-defined condition, at least one of the two or more predictors being generated based on a matrix-multiplication mode of the plurality of candidate intra prediction modes such that the at least one of the two or more predictors is obtained by a matrix multiplication of a matrix of weight coefficients and neighboring reconstructed samples in a template of the current block; and reconstructing the current block based on a weighted combination of the two or more predictors.

(2) The method of feature (1), in which the determining the two or more predictors further includes: applying the plurality of candidate intra prediction modes to reference samples of the template of the current block to generate a plurality of prediction values of the template; determining a plurality of cost values between each of the plurality of prediction values and a reconstructed value of the template; and determining the two or more predictors based on two or more candidate intra prediction modes of the plurality of candidate intra prediction modes that correspond to cost values of the plurality of cost values larger than a threshold value.

(3) The method of feature (1) or (2), in which the two or more predictors are two predictors that are generated by the matrix-multiplication mode, a first one of the two predictors being obtained by a first matrix multiplication of a first matrix of weight coefficients and the neighboring reconstructed samples of the template and a second one of the two predictors being obtained by a second matrix multiplication of a second matrix of weight coefficients and the neighboring reconstructed samples of the template.

(4) The method of any one of features (1) to (3), in which the two or more predictors are two predictors, a first one of the two predictors being generated by the matrix-multiplication mode, and a second one of the two predictors being generated by one of an angular mode, a planar mode, and a DC mode.

(5) The method of any one of features (1) to (4), in which the pre-defined condition includes one of: a size of the current block is smaller than a pre-defined value, a ratio between a width of the current block and a height of the current block is smaller than a pre-defined value, the width of the current block and the height of the current block is smaller than a pre-defined value, and a size of the template is equal to a pre-defined size.

(6) The method of any one of features (1) to (5), in which the plurality of candidate intra prediction modes includes one of a planar mode, a DC mode, a mode equal to (2+4×K) when K is constrained to an integer from 0 to 16, and a mode equal to (2+2×K) when K is constrained to an integer from 0 to 32.

(7) A method of video decoding, the method including: receiving a video bitstream including coded information of a current block in a current picture, the coded information indicating a plurality of pre-defined merge candidates for the current block; refining the plurality of pre-defined merge candidates to generate a plurality of refined merge candidates based on intra template matching between a template of the current block and one or more candidate templates associated with each of the plurality of pre-defined merge candidates; and reconstructing the current block based on the plurality of refined merge candidates.

(8) The method of feature (7), in which the plurality of pre-defined merge candidates includes: a first group of pre-defined merge candidates positioned along an angle of πk/8 with respect to a horizontal axis, k being an integer from 0 to 12, and a second group of pre-defined merge candidates positioned at an upper right corner, an upper left corner, and a lower-left corner of the current block.

(9) The method of feature (7) or (8), in which the refining the plurality of pre-defined merge candidates further includes: determining a refinement window associated with a first one of the plurality of pre-defined merge candidates; determining one of more candidate templates in the refinement window; calculating one or more templating matching (TM) costs based on the one or more candidate templates and the template of the current block; and determining a first one of the plurality of refined merge candidates that corresponds to a minimum TM cost of the one or more TM costs.

(10) The method of any one of features (7) to (9), further including: combining two or more of the plurality of refined merge candidates when an overlapped area of the two or more of the plurality of refined merge candidates is larger than a threshold.

(11) The method of any one of features (7) to (10), further including: deriving a merge candidate list based on the plurality of pre-defined merge candidates and the plurality of refined merge candidates; and the deriving further comprises: replacing a first pre-defined merge candidate of the plurality of pre-defined merge candidates with a first refined merge candidate of the plurality of refined merge candidates when the first pre-defined merge candidate and the first refined merge candidate are within a refinement window; and keeping both the first pre-defined merge candidate and the first refined merge candidate when a distance between the first pre-defined merge candidate and the first refined merge candidate is larger than the refinement window.

(12) The method of any one of features (7) to (11), in which the refining the plurality of pre-defined merge candidates further includes: determining one or more refinement positions associated with a first pre-defined merge candidate of the plurality of pre-defined merge candidates, the one or more refinement positions including one of a top-right corner, a top-left corner, a bottom-left corner, and a bottom-right corner of the first pre-defined merge candidate; determining one or more candidate templates at the one or more refinement positions; calculating one or more templating matching (TM) costs based on the one or more candidate templates and the template of the current block; and determining a first refined merge candidate of the plurality of refined merge candidates that corresponds to a minimum TM cost of the one or more TM costs.

(13) The method of any one of features (7) to (12), in which the refining the plurality of pre-defined merge candidates further includes: when a first refined merge candidate of the plurality of refined merge candidates has a size larger than a threshold size; partitioning the first refined merge candidate into a plurality of sub-blocks based on the threshold size; deriving an intra prediction mode for each of the plurality of sub-blocks; and updating the first refined merge candidate as a most frequent one of the derived intra prediction modes.

(14) The method of any one of features (7) to (13), in which the template of the current block has a size of 2 lines of neighboring samples when a size of the current block is equal to or less than a threshold value, and the template of the current block has a size of 4 lines of neighboring samples when the size of the current block is larger than a threshold value.

(15) A method of video decoding, the method including: receiving a video bitstream including coded information of a current block in a current picture; performing a spatial to spectrum transform on a reference region of the current block to generate a first row of transform coefficients corresponding to a first row of neighboring reconstructed samples of the reference region and a first column of transform coefficients corresponding to a first column of neighboring reconstructed samples of the reference region, the first row of neighboring reconstructed samples being at a top side of the current block and the first column of neighboring reconstructed samples being at a left side of the current block; determining a plurality of transform coefficients corresponding to samples of the current block based on the first row of transform coefficients and the first column of transform coefficients; and reconstructing the samples of the current block by performing an inverse transform on the plurality of transform coefficients.

(16) The method of feature (15), in which the determining the plurality of transform coefficients corresponding to the samples of the current block further includes: determining each of the plurality of transform coefficients based on (i) one of the first row of transform coefficients that has a same horizontal coordinate as the respective one of the plurality of transform coefficients and (ii) one of the first column of transform coefficients that has a same vertical coordinate as the respective one of the plurality of transform coefficients.

(17) The method of feature (15) or (16), in which the performing the spatial to spectrum transform further includes: determining a first DC coefficient of the first row of transform coefficients corresponding to a neighboring sample at a top-left corner of the current block; determining a second DC coefficient of the first column of transform coefficients corresponding to the neighboring sample at the top-left corner of the current block such that the first DC coefficient and the second DC coefficient are overlapped; and merging the first DC coefficient and the second DC coefficient to obtain a DC coefficient corresponding to the neighboring sample at the top-left corner of the current block.

(18) The method of any one of features (15) to (17), in which the determining the plurality of transform coefficients corresponding to the samples of the current block further includes: determining each of the plurality of transform coefficients by merging (i) one of the first row of transform coefficients that has a same horizontal coordinate as the respective one of the plurality of transform coefficients and (ii) one of the first column of transform coefficients that has a same vertical coordinate as the respective one of the plurality of transform coefficients.

(19) The method of any one of features (15) to (18), in which the reconstructing the samples of the current block further includes: performing the inverse transform on the plurality of transform coefficients corresponding to the samples of the current block to generate a plurality of initial prediction samples of the current block; adjusting each of plurality of initial prediction samples by a regression formula to obtain a plurality of prediction samples of the current block, the regression formula being equal to a×Val+b, Val being the respective one of the plurality of initial prediction samples, a and b being constants determined from samples of the reference region and prediction samples of the reference region; and reconstructing the current block based on the plurality of prediction samples of the current block.

(20) The method of any one of features (15) to (19), in which the reference region further includes a second row of neighboring reconstructed samples at a top side of the first row of neighboring reconstructed samples and a second column of neighboring reconstructed samples at a left side of the first column of neighboring reconstructed samples.

(21) An apparatus for video decoding, including processing circuitry that is configured to perform the method of any of features (1) to (6).

(22) An apparatus for video decoding, including processing circuitry that is configured to perform the method of any of features (7) to (14).

(23) An apparatus for video decoding, including processing circuitry that is configured to perform the method of any of features (15) to (20).

(23) A non-transitory computer-readable storage medium storing instructions which when executed by at least one processor cause the at least one processor to perform the method of any of features (1) to (20).

What is claimed is:

1. A method of video decoding, the method comprising:
receiving a video bitstream including coded information of a current block in a current picture, the coded information indicating a plurality of candidate intra prediction modes for the current block;
determining two or more predictors based on the plurality of candidate intra prediction modes for the current block according to a pre-defined condition, at least one of the two or more predictors being generated based on a matrix-multiplication mode of the plurality of candidate intra prediction modes such that the at least one of the two or more predictors is obtained by a matrix multiplication of a matrix of weight coefficients and neighboring reconstructed samples in a template of the current block; and
reconstructing the current block based on a weighted combination of the two or more predictors.

2. The method of claim 1, wherein the determining the two or more predictors further comprises:
applying the plurality of candidate intra prediction modes to reference samples of the template of the current block to generate a plurality of prediction values of the template;
determining a plurality of cost values between each of the plurality of prediction values and a reconstructed value of the template; and
determining the two or more predictors based on two or more candidate intra prediction modes of the plurality of candidate intra prediction modes that correspond to cost values of the plurality of cost values larger than a threshold value.

3. The method of claim 1, wherein the two or more predictors are two predictors that are generated by the matrix-multiplication mode, a first one of the two predictors being obtained by a first matrix multiplication of a first matrix of weight coefficients and the neighboring reconstructed samples of the template and a second one of the two predictors being obtained by a second matrix multiplication of a second matrix of weight coefficients and the neighboring reconstructed samples of the template.

4. The method of claim 1, wherein the two or more predictors are two predictors, a first one of the two predictors being generated by the matrix-multiplication mode, and a second one of the two predictors being generated by one of an angular mode, a planar mode, and a DC mode.

5. The method of claim 1, wherein the pre-defined condition includes one of:
a size of the current block is smaller than a pre-defined value,
a ratio between a width of the current block and a height of the current block is smaller than a pre-defined value,
the width of the current block and the height of the current block is smaller than a pre-defined value, and
a size of the template is equal to a pre-defined size.

6. The method of claim 1, wherein the plurality of candidate intra prediction modes includes one of a planar mode, a DC mode, a mode equal to (2+4×K) when K is constrained to an integer from 0 to 16, and a mode equal to (2+2×K) when K is constrained an integer from 0 to 32.

7. A method of video decoding, the method comprising:
receiving a video bitstream including coded information of a current block in a current picture, the coded information indicating a plurality of pre-defined merge candidates for the current block;
refining the plurality of pre-defined merge candidates to generate a plurality of refined merge candidates based on intra template matching between a template of the current block and one or more candidate templates associated with each of the plurality of pre-defined merge candidates; and
reconstructing the current block based on the plurality of refined merge candidates.

8. The method of claim 7, wherein the plurality of pre-defined merge candidates includes:
a first group of pre-defined merge candidates positioned along an angle of πk/8 with respect to a horizontal axis, k being an integer from 0 to 12, and
a second group of pre-defined merge candidates positioned at an upper right corner, an upper left corner, and a lower-left corner of the current block.

9. The method of claim 7, wherein the refining the plurality of pre-defined merge candidates further comprises:
determining a refinement window associated with a first one of the plurality of pre-defined merge candidates;
determining one or more candidate templates in the refinement window;
calculating one or more templating matching (TM) costs based on the one or more candidate templates and the template of the current block; and
determining a first one of the plurality of refined merge candidates that corresponds to a minimum TM cost of the one or more TM costs.

10. The method of claim 7, further comprising:
combining two or more of the plurality of refined merge candidates when an overlapped area of the two or more of the plurality of refined merge candidates is larger than a threshold.

11. The method of claim 7, further comprising:
deriving a merge candidate list based on the plurality of pre-defined merge candidates and the plurality of refined merge candidates; and
the deriving further comprises:
replacing a first pre-defined merge candidate of the plurality of pre-defined merge candidates with a first refined merge candidate of the plurality of refined merge candidates when the first pre-defined merge candidate and the first refined merge candidate are within a refinement window.

12. The method of claim 7, wherein the refining the plurality of pre-defined merge candidates further comprises:
determining one or more refinement positions associated with a first pre-defined merge candidate of the plurality of pre-defined merge candidates, the one or more refinement positions including one of a top-right corner, a top-left corner, a bottom-left corner, and a bottom-right corner of the first pre-defined merge candidate;
determining one or more candidate templates at the one or more refinement positions;
calculating one or more templating matching (TM) costs based on the one or more candidate templates and the template of the current block; and
determining a first refined merge candidate of the plurality of refined merge candidates that corresponds to a minimum TM cost of the one or more TM costs.

13. The method of claim 7, wherein the refining the plurality of pre-defined merge candidates further comprises:
when a first refined merge candidate of the plurality of refined merge candidates has a size larger than a threshold size;
partitioning the first refined merge candidate into a plurality of sub-blocks based on the threshold size;
deriving an intra prediction mode for each of the plurality of sub-blocks; and
updating the first refined merge candidate as a most frequent one of the derived intra prediction modes.

14. The method of claim 7, wherein the template of the current block has a size of 2 lines of neighboring samples when a size of the current block is equal to or less than a threshold value, and the template of the current block has a size of 4 lines of neighboring samples when the size of the current block is larger than a threshold value.

15. A method of video decoding, the method comprising:
receiving a video bitstream including coded information of a current block in a current picture;
performing a spatial to spectrum transform on a reference region of the current block to generate a first row of transform coefficients corresponding to a first row of neighboring reconstructed samples of the reference region and a first column of transform coefficients corresponding to a first column of neighboring reconstructed samples of the reference region, the first row of neighboring reconstructed samples being at a top side of the current block and the first column of neighboring reconstructed samples being at a left side of the current block;
determining a plurality of transform coefficients corresponding to samples of the current block based on the first row of transform coefficients and the first column of transform coefficients; and
reconstructing the samples of the current block by performing an inverse transform on the plurality of transform coefficients.

16. The method of claim 15, wherein the determining the plurality of transform coefficients corresponding to the samples of the current block further comprises:
determining each of the plurality of transform coefficients based on (i) one of the first row of transform coefficients that has a same horizontal coordinate as the respective one of the plurality of transform coefficients and (ii) one of the first column of transform coefficients that has a same vertical coordinate as the respective one of the plurality of transform coefficients.

17. The method of claim 15, wherein the performing the spatial to spectrum transform further comprises:
determining a first DC coefficient of the first row of transform coefficients corresponding to a neighboring sample at a top-left corner of the current block;
determining a second DC coefficient of the first column of transform coefficients corresponding to the neighboring sample at the top-left corner of the current block such that the first DC coefficient and the second DC coefficient are overlapped; and
merging the first DC coefficient and the second DC coefficient to obtain a DC coefficient corresponding to the neighboring sample at the top-left corner of the current block.

18. The method of claim 15, wherein the determining the plurality of transform coefficients corresponding to the samples of the current block further comprises:
determining each of the plurality of transform coefficients by merging (i) one of the first row of transform coefficients that has a same horizontal coordinate as the respective one of the plurality of transform coefficients and (ii) one of the first column of transform coefficients that has a same vertical coordinate as the respective one of the plurality of transform coefficients.

19. The method of claim 15, wherein the reconstructing the samples of the current block further comprises:
performing the inverse transform on the plurality of transform coefficients corresponding to the samples of the current block to generate a plurality of initial prediction samples of the current block;
adjusting each of plurality of initial prediction samples by a regression formula to obtain a plurality of prediction samples of the current block, the regression formula being equal to a×Val+b, Val being the respective one of the plurality of initial prediction samples, a and b being constants determined from samples of the reference region and prediction samples of the reference region; and
reconstructing the current block based on the plurality of prediction samples of the current block.

20. The method of claim 15, wherein the reference region further includes a second row of neighboring reconstructed samples at a top side of the first row of neighboring reconstructed samples and a second column of neighboring reconstructed samples at a left side of the first column of neighboring reconstructed samples.
